(19) United States
(12) Patent Application Publication
(10) Pub. No.: US 2025/0360967 A1
(43) Pub. Date: Nov. 27, 2025

(54) VEHICLE LOWER PART STRUCTURE

(71) Applicant: TOYOTA JIDOSHA KABUSHIKI KAISHA, Toyota-shi (JP)

(72) Inventor: Katsunori HIGASHIHARA, Toyota-shi (JP)

(73) Assignee: TOYOTA JIDOSHA KABUSHIKI KAISHA, Toyota-shi (JP)

(21) Appl. No.: 19/024,561

(22) Filed: Jan. 16, 2025

(30) Foreign Application Priority Data
May 24, 2024 (JP) 2024-085118

(51) Int. Cl. B62D 25/02; B60K 1/04; B62D 21/15

(52) U.S. Cl. CPC B62D 25/025; B60K 1/04; B62D 21/157; B60K 2001/0438

(57) ABSTRACT

A vehicle lower part structure includes a rocker disposed outward of the battery in the vehicle width direction and extending in the vehicle front-rear direction, a cross member disposed above the battery in the vehicle up-down direction and connecting the rocker in the vehicle width direction, and a lower load transfer member disposed below the battery in a vehicle up-down direction and extending in the vehicle width direction, and bent portions bent in the vehicle vertical direction along the rocker are formed at both end portions of the lower load transfer member in the vehicle width direction, and the bent portions and the rocker are fastened in the vehicle width direction by the fastening member in a state of being superposed.

### CROSS-REFERENCE TO RELATED APPLICATION

This application claims priority to Japanese Patent Application No. 2024-085118 filed on May 24, 2024, incorporated herein by reference in its entirety.

### BACKGROUND

### 1. Technical Field

The present disclosure relates to vehicle lower part structures.

### 2. Description of Related Art

Japanese Unexamined Patent Application Publication No. 2020-104602 (JP 2020-104602 A) discloses a vehicle side structure in which an under reinforcement is disposed between a rocker and a battery case and the rocker and the under reinforcement are connected by a cross member. In the vehicle side structure described in JP 2020-104602 A, a crash box extends from the rocker toward the battery frame so as to absorb impact energy.

### SUMMARY

A battery tends to have a large size in order to increase the range of a vehicle. There is known a structure in which a battery is large enough to extend to near a rocker. A crash box cannot be disposed in such a structure, and this structure has room for improvement in order to maintain collision resistance performance in case of a side-impact collision.

An object of the present disclosure is to provide a vehicle lower part structure that can maintain collision resistance performance in case of a side-impact collision even when a battery has a large size.

A vehicle lower part structure according to claim 1 includes: a rocker disposed outward of a battery in a vehicle width direction and extending in a vehicle front-rear direction;
a cross member disposed above the battery in a vehicle up-down direction and connecting the rockers in the vehicle width direction; and
a lower load transfer member disposed below the battery in the vehicle up-down direction and extending in the vehicle width direction.
   Both end portions in the vehicle width direction of the lower load transfer member include a bent portion bent in the vehicle up-down direction along the rocker.
   The bent portion and the rocker are fastened together in the vehicle width direction with a fastening member so as to face each other.

In the vehicle lower part structure of claim 1, the rocker is disposed outward of the battery in the vehicle width direction. The rocker extends in the vehicle front-rear direction. The cross member is disposed above the battery in the vehicle up-down direction. The cross member connects the rockers in the vehicle width direction. The lower load transfer member is disposed below the battery in the vehicle up-down direction. The lower load transfer member extends in the vehicle width direction. Both end portions in the vehicle width direction of the lower load transfer member include the bent portion bent in the vehicle up-down direction along the rocker. The bent portion and the rocker are fastened together in the vehicle width direction with the fastening member so as to face each other. This configuration allows an impact load to be transferred from the rocker to the opposite side from the impact via the cross member and the lower load transfer member in case of a side-impact collision (side collision) of a vehicle.

In particular, since the impact load can be distributed to the cross member and the lower load transfer member, the impact load can be more effectively transferred compared to a configuration in which the impact load is transferred only via either a member located above the battery or a member located below the battery. Since the bent portion and the rocker are fastened together in the vehicle width direction with the fastening member, the impact load is transferred in an axial direction of the fastening member. Therefore, the fastened state can be better maintained compared to a configuration in which the impact load is transferred in a shearing direction of the fastening member.

According to the vehicle lower part structure of claim 2, in claim 1, the bent portion may be bent downward in the vehicle up-down direction along the rocker.

In the vehicle lower part structure according to claim 2, the bent portion is bent downward in the vehicle up-down direction. Therefore, a general portion of the lower load transfer member can be disposed at an upper position compared to a configuration in which the bent portion is bent upward in the vehicle up-down direction. This can reduce interference with a road surface.

According to the vehicle lower part structure of claim 3, in claim 1, the lower load transfer member may include a panel member extending in the vehicle width direction and the vehicle front-rear direction and covering the battery from below.

In the vehicle lower part structure of claim 3, the battery can be extensively protected from below in the vehicle up-down direction by the panel member. The panel member can also distribute an impact load in the vehicle width direction and the vehicle front-rear direction in case of a side collision.

According to the vehicle lower part structure of claim 4, in claim 3, a reinforcing member extending in the vehicle front-rear direction and having a closed cross section together with the panel member may be provided on a lower surface of the panel member.

In the vehicle lower part structure of claim 4, the panel member is reinforced by the reinforcing member. This can reduce buckling of the panel member when an impact load is applied.

According to the vehicle lower part structure of claim 5, in any one of claims 1 to 4,
a battery frame may be disposed between the cross member and the rocker,
the battery may be fastened to the battery frame, and
the battery frame may be fastened to the rocker.

In the vehicle lower part structure of claim 5, the battery frame and the rocker can be fastened together with the battery fastened to the battery frame. This can improve work efficiency during assembly of the vehicle compared to a configuration in which the battery is directly fastened to the rocker.

As described above, the vehicle lower part structure according to the present disclosure can maintain collision resistance performance in case of a side-impact collision even when the battery has a large size.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a part of a vehicle lower part structure according to an embodiment;

FIG. 2 is a cross-sectional view taken along line 2-2 of FIG. 1; and

FIG. 3 is an enlarged cross-sectional view showing a main part of FIG. 2 in an enlarged manner.

### DETAILED DESCRIPTION OF EMBODIMENTS

A vehicle lower part structure according to an embodiment will be described with reference to the drawings.

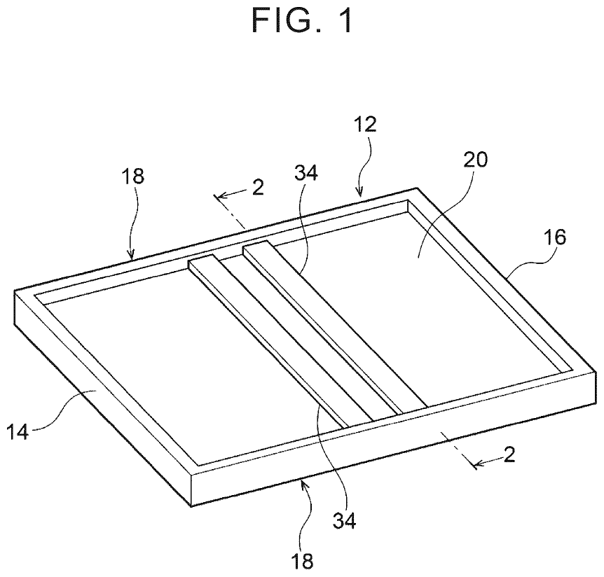

FIG. 1 is a perspective view illustrating a part of a vehicle lower part structure according to an embodiment. Note that the arrow FR, the arrow UP, and the arrow RH in the drawing respectively indicate the vehicle front direction, the vehicle upper direction, and the vehicle right direction in the vehicle 10 to which the vehicle lower part structure is applied. In the following description, when the front, rear, up, down, right, and left are used without special mention, front and rear in the vehicle front-rear direction, up and down in the vehicle up-down direction, and right and left in the vehicle left-right direction (width direction) are respectively indicated.

As shown in FIG. 1, the vehicle lower part structure of the present embodiment includes a battery frame 12. The battery frame 12 is a substantially frame-shaped member that surrounds the battery case 20, and is disposed below a vehicle cabin, not shown.

The battery frame 12 includes a front frame 14, a rear frame 16, and a pair of right and left side frames 18. The front frame 14, the rear frame 16, and the side frame 18 may be integrally formed of metal or may be separately formed. In the present embodiment, as an example, the front frame 14, the rear frame 16, and the side frame 18 are formed by extrusion molding to have a closed cross-sectional structure, and are joined to each other to form the battery frame 12.

The front frame 14 is located in the vehicle front portion of the vehicle lower part structure, and extends in the vehicle width direction along the vehicle front end portion of the battery case 20. Further, a front module (not shown) constituting a front portion of the vehicle is joined to the front frame 14.

The rear frame 16 is located at the vehicle rear portion of the vehicle lower part structure, and extends in the vehicle width direction along the vehicle rear end portion of the battery case 20. Further, a rear module (not shown) constituting a rear portion of the vehicle is joined to the rear frame 16.

The right end portion of the front frame 14 and the right end portion of the rear frame 16 are connected in the vehicle front-rear direction by the side frame 18. Further, the left end portion of the front frame 14 and the left end portion of the rear frame 16 are connected in the vehicle front-rear direction by the side frame 18.

Each of the pair of right and left side frames 18 is located outward of the battery case 20 in the vehicle width direction and extends in the vehicle front-rear direction.

A front end portion of the side frame 18 is connected to the front frame 14, and a rear end portion of the side frame 18 is connected to the rear frame 16.

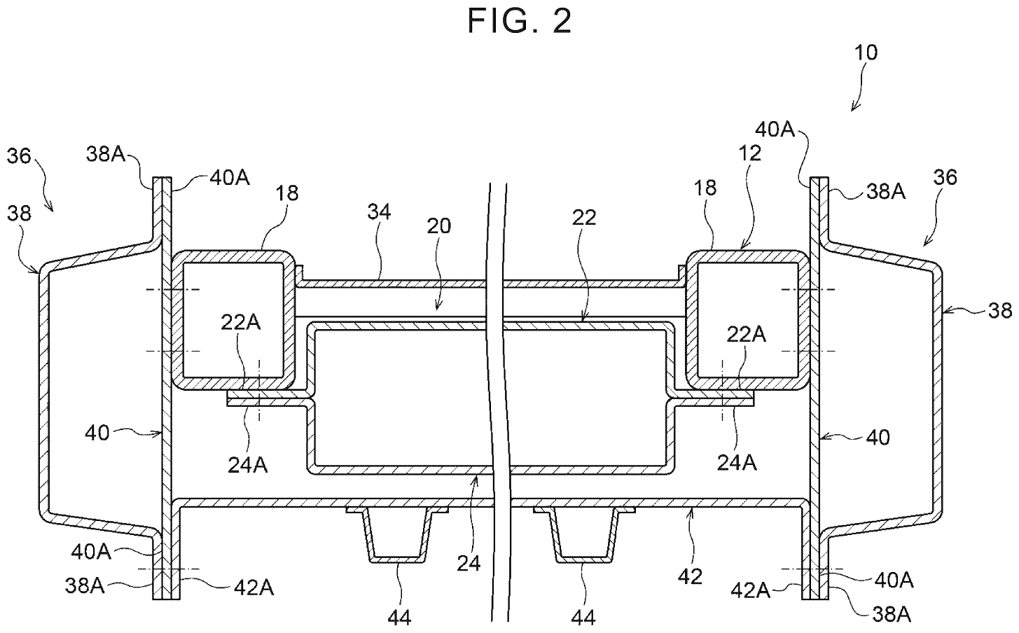

FIG. 2 is an enlarged cross-sectional view of a main part taken along line 2-2 of FIG. 1. As shown in FIG. 2, the battery case 20 includes an upper case 22 and a lower case 24, and a battery is housed inside the battery case 20.

The upper case 22 is formed in a substantially hat shape in which its lower side in the vehicle up-down direction is open in a cross-sectional view viewed from the vehicle front-rear direction. Upper-side flanges 22A are formed at both ends in the vehicle width direction of the upper case 22 so as to be superimposed on the lower surfaces of the right and left side frames 18.

The lower case 24 is formed in a substantially hat shape in which its upper side in the vehicle up-down direction is open in a sectional view viewed from the vehicle front-rear direction. At both ends in the vehicle width direction of the lower case 24, a lower-side flange 24A is formed to be superimposed on the upper-side flange 22A of the upper case 22. The upper-side flange 22A and the lower-side flange 24A are mechanically fastened to the side frame 18.

In the present embodiment, as an example, the floor panel is not disposed, and the upper case 22 of the battery case 20 constitutes the floor surface of the vehicle cabin. However, the present disclosure is not limited thereto, and a configuration may be adopted in which a floor panel is provided above the upper case 22 in the vehicle up-down direction.

Cross members 34 are installed in the right and left side frames 18 constituting the battery frame 12. As illustrated in FIG. 1, in the present embodiment, as an example, two cross members 34 are provided in the vehicle front-rear direction, and each cross member extends in the vehicle width direction.

As shown in FIG. 2, both end portions of the cross member 34 in the vehicle width direction are bent upward in the vehicle up-down direction along the side frame 18, and are fixed to the side frame 18. The method of fixing the cross member 34 to the side frame 18 is not particularly limited, and may be mechanically fastened using a bolt, a nut, or the like, or may be joined by welding or the like. In addition, bonding may be performed by an adhesive, a pressure-sensitive adhesive, or the like, and these methods may be combined.

A rocker 36 is disposed outward of the battery case 20 in the vehicle width direction. A pair of right and left rockers 36 is a skeletal member extending in the vehicle front-rear direction. The rocker 36 includes a rocker outer panel 38 disposed on the outer side in the vehicle width direction and a rocker inner panel 40 disposed on the inner side in the vehicle width direction.

The rocker outer panel 38 is formed in a substantially hat shape in which the vehicle widthwise direction inner side is opened in a cross-sectional view viewed from the vehicle front-rear direction, and an outer-side flange 38A extending in the vehicle up-down direction is formed at both upper and lower end portions.

The rocker inner panel 40 is formed substantially in the shape of a flat plate having a vehicle width direction as a thickness direction. An inner-side flange 40A is formed at an upper end portion and a lower end portion of the rocker inner panel 40 so as to be superimposed on the outer-side flange 38A of the rocker outer panel 38. The outer-side flange 38A and the inner-side flange 40A are joined to each other by welding or the like in a superposed manner. Note that an energy absorbing material or the like may be disposed in a closed cross section formed by the rocker outer panel 38 and the rocker inner panel 40.

The rocker inner panel 40 is in contact with the outer surface in the vehicle width direction of the side frame 18 of the battery frame 12, and the rocker outer panel 38 and the side frame 18 are mechanically fastened. As described above, the rocker 36 is fixed to the side frame 18, so that the right and left rockers 36 are connected in the vehicle width direction by the cross member 34.

A panel member 42 as a lower load transfer member is provided below the battery case 20 in the vehicle up-down direction. The panel member 42 extends in the vehicle width direction and the vehicle front-rear direction, and connects the right and left rockers 36 in the vehicle width direction. Further, the panel member 42 is formed in a substantially flat plate shape so as to cover the battery case 20 from below in the vehicle up-down direction. Here, a plurality of reinforcing members 44 are provided on the lower surface of the panel member 42.

Each of the reinforcing members 44 extends in the vehicle front-rear direction, and is formed in a substantially hat-shaped section in which its upper side in the vehicle up-down direction is open as viewed from the vehicle front-rear direction. A closed cross section is formed between the panel member 42 and each reinforcing member 44. In the present embodiment, as an example, the reinforcing members 44 are arranged at equal intervals in the vehicle width direction.

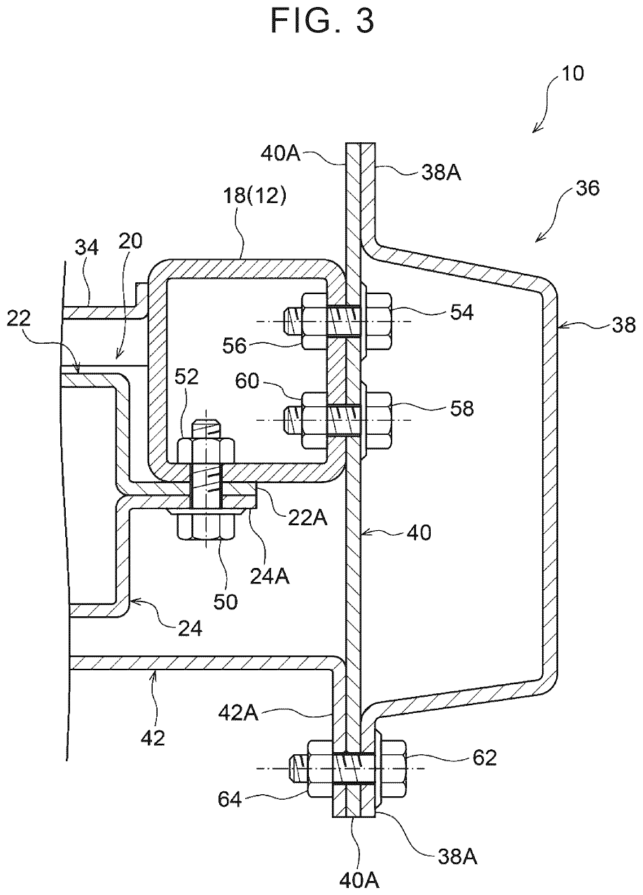

Next, a fastening structure of the battery case 20, the battery frame 12, the rocker 36, and the panel member 42 will be described with reference to FIG. 3.

FIG. 3 is an enlarged cross-sectional view showing a main part of FIG. 2 in an enlarged manner. As shown in FIG. 3, the battery case 20 and the battery frame 12 are mechanically fastened by the first bolt 50 and the first nut 52. Specifically, the first bolt 50 is inserted from the lower side of the battery case 20, and the first bolt 50 is screwed into the first nut 52 in the battery frame 12. The first bolt 50 may be a welded nut previously welded to the battery frame 12, or may be attached through a working hole (not shown) formed in the battery frame 12.

The battery frame 12 and the rocker 36 are mechanically fastened by the second bolt 54, the third bolt 58, the second nut 56, and the third nut 60. Specifically, the upper portion of the battery frame 12 and the rocker inner panel 40 are mechanically fastened by the second bolt 54 and the second nut 56. The lower portion of the battery frame 12 and the rocker inner panel 40 are mechanically fastened by the third bolt 58 and the third nut 60.

The second bolt 54 and the second bolt 54 are inserted into the rocker inner panel 40 and the battery frame 12 through a working hole (not shown) formed in the rocker outer panel 38, and are screwed to the second nut 56 and the third nut 60, respectively.

The panel member 42 and the rocker 36 are mechanically fastened by a fourth bolt 62 and a fourth nut 64. Specifically, at both end portions of the panel member 42 in the vehicle width direction, a bent portion 42A bent downward in the vehicle up-down direction along the rocker 36 is formed. The fourth bolt 62 and the fourth nut 64 are fastened to each other in the vehicle width direction with the bent portion 42A and the rocker 36 superposed on each other. Therefore, three members of the rocker outer panel 38, the rocker inner panel 40, and the bent portion 42A are mechanically fastened by the fourth bolt 62 and the fourth nut 64. In the present embodiment, the fourth bolt 62 is inserted from outside in the vehicle width direction as an example, but the present disclosure is not limited thereto, and the fourth bolt 62 may be inserted from inside in the vehicle width direction. In this case, the fourth nut 64 is disposed on the rocker outer panel 38 side.

### Operations

Next, the operation of the vehicle lower part structure according to the present embodiment will be described.

In the vehicle lower part structure according to the present embodiment, the rocker 36 is disposed outward of the battery case 20 in the vehicle width direction, and the rocker 36 extends in the vehicle front-rear direction. Further, a cross member 34 is disposed above the battery case 20 in the vehicle up-down direction, and the cross member 34 connects the rocker 36 in the vehicle width direction via the battery frame 12. Further, a panel member 42 is disposed below the battery in the vehicle up-down direction, and the panel member 42 extends in the vehicle width direction. Bent portions 42A bent in the vehicle vertical direction along the rocker 36 are formed at both end portions of the panel member 42 in the vehicle widthwise direction. The fourth bolt 62 and the fourth nut 64, which are fastening members, are fastened to each other in the vehicle width direction with the bent portion 42A and the rocker 36 overlapped with each other. Accordingly, the impact load can be transferred from the rocker 36 to the anti-collision side through the cross member 34 and the panel member 42 in case of a side collision of the vehicle.

In particular, since the cross member 34 and the panel member 42 can disperse the impact load in the upper and lower portions of the battery frame 12, the impact load can be more effectively transferred as compared with a configuration in which the impact load is transferred by only either a member above the battery case 20 or a member below the battery case 20. The bent portion 42A and the rocker 36 are fastened to each other in the vehicle width direction with the fourth bolt 62 and the fourth nut 64. Therefore, the impact load is transferred in the axial direction of the fourth bolt 62, and the fastening state can be better maintained as compared with a configuration in which the impact load is transferred in the shear direction of the bolt. As a result, it is possible to maintain collision resistance performance in case of a side collision even when the battery has a large size.

Further, in the vehicle lower part structure according to the present embodiment, since the bent portion 42A is bent downward in the vehicle up-down direction, the normal portion of the panel member 42 can be arranged upward as compared with a configuration in which the bent portion 42A is bent upward in the vehicle up-down direction, and thus it is possible to suppress the interference with the road surface. That is, in a case where the bent portion bent upward in the vehicle up-down direction from the general portion of the panel member and the rocker are fastened, the height of the general portion of the panel member is substantially the same as the height of the lower end portion of the rocker, and thus there is a possibility that the height of the general portion of the panel member may interfere with an obstacle such as a falling object on the road surface. On the other hand, in the present embodiment, in the panel member 42, the gap between the normal portion except for the bent portion 42A and the road surface can be secured wide, so that it is possible to suppress the obstacles on the road surface from interfering with each other.

Further, in the present embodiment, the battery case 20 can be extensively protected from below in the vehicle up-down direction by the panel member 42. The panel member 42 can disperse the impact load in case of a side collision in the vehicle width direction and the vehicle front-rear direction.

Furthermore, in the present embodiment, as shown in FIG. 2, the panel member 42 is reinforced by the reinforcing members 44, so that it is possible to prevent the panel member 42 from buckling when an impact load is input.

Further, in the present embodiment, the battery frame 12 and the rocker 36 can be fastened in a state in which the battery case 20 is fastened to the battery frame 12. Therefore, compared with a configuration in which the battery case 20 is directly fastened to the rocker 36, it is possible to improve the work efficiency at the time of assembling the vehicle.

Although the vehicle lower part structure according to the embodiment has been described above, it is needless to say that the present disclosure can be implemented in various forms without departing from the gist of the present disclosure. For example, in the above-described embodiment, the rocker 36 and the battery frame 12 are fastened by two bolts, i.e., the second bolt 54 and the third bolt 58, but the present disclosure is not limited thereto. For example, it may be fastened by one bolt in the up-down direction.

Further, in the above embodiment, the bent portion 42A is bent downward in the vehicle up-down direction, but the present disclosure is not limited thereto, and may be bent upward in the vehicle up-down direction. Further, instead of the panel member 42 of the above-described embodiment, a lower load transfer member substantially in the shape of a belt may be provided.

With respect to the above embodiments, the following supplementary notes are disclosed.

### Appendix 1

A vehicle lower part structure includes:
a rocker disposed outward of the battery in the vehicle width direction and extending in the vehicle front-rear direction;
a cross member disposed above the battery in the vehicle up-down direction and connecting the rocker in the vehicle width direction; and
a lower load transfer member disposed below the battery in the vehicle up-down direction and extending in a vehicle width direction, wherein:
a bent portion bent in the vehicle vertical direction along the rocker is formed at both end portions of the lower load transfer member in the vehicle width direction; and
the bent portion and the rocker are fastened in the vehicle width direction by a fastening member in a state of being overlapped.

### Appendix 2

The vehicle lower part structure according to Appendix 1, wherein the bent portion is bent downward in the vehicle up-down direction along the rocker.

### Appendix 3

The vehicle lower part structure according to Appendix 1 or 2, wherein the lower load transfer member includes a panel member extending in a vehicle width direction and a vehicle front-rear direction and covering the battery from below.

### Appendix 4

The vehicle lower part structure according to Appendix 3, wherein a reinforcing member extending in the vehicle front-rear direction and forming a closed cross section with the panel member is provided on a lower surface of the panel member.

### Appendix 5

The vehicle lower part structure according to any one of Appendices 1 to 4, wherein:
a battery frame is disposed between the cross member and the rocker;
the battery is fastened to the battery frame; and
the battery frame is fastened to the rocker.

What is claimed is:

1. A vehicle lower part structure comprising:
a rocker disposed outward of a battery in a vehicle width direction and extending in a vehicle front-rear direction;
a cross member disposed above the battery in a vehicle up-down direction and connecting the rockers in the vehicle width direction; and
a lower load transfer member disposed below the battery in the vehicle up-down direction and extending in the vehicle width direction, wherein:
both end portions in the vehicle width direction of the lower load transfer member include a bent portion bent in the vehicle up-down direction along the rocker; and
the bent portion and the rocker are fastened together in the vehicle width direction with a fastening member so as to face each other.

2. The vehicle lower part structure according to claim 1, wherein the bent portion is bent downward in the vehicle up-down direction along the rocker.

3. The vehicle lower part structure according to claim 1, wherein the lower load transfer member includes a panel member extending in the vehicle width direction and the vehicle front-rear direction and covering the battery from below.

4. The vehicle lower part structure according to claim 3, wherein a reinforcing member extending in the vehicle front-rear direction and has a closed cross section together with the panel member is provided on a lower surface of the panel member.

5. The vehicle lower part structure according to claim 1, wherein:
a battery frame is disposed between the cross member and the rocker;
the battery is fastened to the battery frame; and
the battery frame is fastened to the rocker.
